(19) United States
(12) Patent Application Publication
(10) Pub. No.: US 2026/0003201 A1
(43) Pub. Date: Jan. 1, 2026

(54) ILLUMINATION DEVICE

(71) Applicant: QISDA CORPORATION, Taoyuan City (TW)

(72) Inventors: Ching-Tze Huang, Taoyuan City (TW); Kai-Jiun Wang, Taoyuan City (TW)

(73) Assignee: QISDA CORPORATION, Taoyuan City (TW)

(21) Appl. No.: 19/021,237

(22) Filed: Jan. 15, 2025

(30) Foreign Application Priority Data
Jun. 28, 2024 (CN) 202410858578.4

(51) Int. Cl. G02B 27/09

(52) U.S. Cl. CPC G02B 27/0955

(57) ABSTRACT

An illumination device includes an asymmetric laser light source, a beam adjustment module and an anisotropic diffusion module. The asymmetric laser light source is adapted to output an illumination light beam having different sizes in a first direction and a second direction that are interlaced with each other. The beam adjustment module is adapted to adjust a beam size of the illumination light beam. The anisotropic diffusion module is disposed between the asymmetric laser light source and the beam adjustment module. The anisotropic diffusion module has different optical properties along the first direction and the second direction, and the beam size of the illumination light beam is consistent in the first direction and the second direction.

### BACKGROUND OF THE INVENTION

### 1. Field of the Invention

The present invention relates to an illumination device, and more particularly, to an illumination device of providing uniform color illumination.

### 2. Description of the Prior Art

A conventional solid-state light source directly disposes the lens array on the laser chip to generate collimated laser light. However, the laser chip includes multiple laser units, and the substrate of the laser chip may have an asymmetrical aspect ratio in accordance with arrangement of the laser units, which causes obvious difference in collimation of the laser light in different directions that are perpendicular to each other. If the laser light passes through the beam expansion module, the beam sizes of the laser light in two different directions are inconsistent; when the laser light is guided into the light guide through the light convergence module, the incident angle of the laser light in the two different directions are different, and the reflection number of the laser light entering the light pipe in two different directions are different, which easily leads to poor color uniformity. Therefore, design of a projection device that can improve poor color uniformity is an important issue in the optical apparatus industry.

### SUMMARY OF THE INVENTION

The present invention provides an illumination device of providing uniform color illumination for solving above drawbacks.

According to the claimed invention, an illumination device includes an asymmetric laser light source, a beam adjustment module and an anisotropic diffusion module. The asymmetric laser light source is adapted to emit an illumination light beam having different sizes in a first direction and a second direction that are interlaced with each other. The beam adjustment module is adapted to adjust a beam size of the illumination light beam. The anisotropic diffusion module is disposed between the asymmetric laser light source and the beam adjustment module. The anisotropic diffusion module has different optical properties in the first direction and the second direction, and the beam size of the illumination light beam is consistent in the first direction and the second direction.

According to the claimed invention, the illumination device further includes a light convergence module and a light collecting module. The light convergence module is disposed adjacent to the beam adjustment module. The light collecting module is disposed on a side of the light convergence module opposite to the beam adjustment module. The anisotropic diffusion module is adapted to project the illumination light beam into the light collecting module at the same angle in both the first direction and the second direction.

According to the claimed invention, the illumination device further includes a lens assembly, a projection pattern generator, a light refracting component and a projection lens. The lens assembly is disposed adjacent to the beam adjustment module. The projection pattern generator is disposed on a side of the lens assembly opposite to the beam adjustment module. The light refracting component is disposed adjacent to the projection pattern generator. The projection lens is disposed adjacent to the light refracting component. The anisotropic diffusion module is adapted to increase a spot area of the illumination light beam projected onto the lens assembly, and the illumination light beam passes through the projection pattern generator and the light refracting component to arrive the projection lens.

The illumination device of the present invention can dispose the anisotropic diffusion module in front of the asymmetric laser light source, and the illumination light beam of the asymmetric laser light source can have different beam sizes in different directions due to arrangement of the laser units of the asymmetric laser light source, so that different optical homogenization features of the anisotropic diffusion module in different directions can be utilized to correct or calibrate the illumination light beam, and the illumination light beam converged into the light collecting module can have the same incident angle in different directions, for effectively increasing color uniformity of illumination. The illumination device of the present invention is not limited to various types of projection apparatus; any optical apparatus that needs to improve poor color uniformity can belong to a design scope of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an architecture diagram of an illumination device according to an embodiment of the present invention.

FIG. 2 is a diagram of an asymmetric laser light source according to the embodiment of the present invention.

FIG. 3 and FIG. 4 are lateral views of the asymmetric laser light source in other view angles according to the embodiment of the present invention.

FIG. 5 is an architecture diagram of the illumination device according to another embodiment of the present invention.

FIG. 6 to FIG. 8 are diagrams of an anisotropic diffusion module according to different embodiments of the present invention.

FIG. 9 is a diagram of difference in an illumination light beam emitted by the illumination device and entering a light collecting module along different directions according to the embodiment of the present invention.

### DETAILED DESCRIPTION

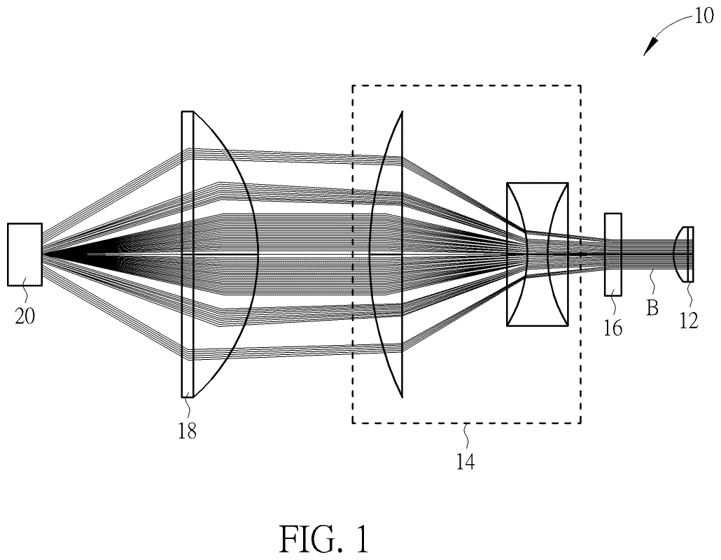

Please refer to FIG. 1. FIG. 1 is an architecture diagram of an illumination device 10 according to an embodiment of the present invention. The illumination device 10 can optionally include an asymmetric laser light source 12, a beam adjustment module 14, an anisotropic diffusion module 16, a light convergence module 18 and a light collecting module 20. The anisotropic diffusion module 16 can be preferably disposed between the asymmetric laser light source 12 and the beam adjustment module 14, or may be optionally disposed on other position, such as a side of the beam adjustment module 14 opposite to the asymmetric laser light source 12; position variation of the anisotropic diffusion module 16 can depend on a design demand. The light convergence module 18 can be disposed adjacent to the beam adjustment module 14. The light collecting module 20 can be disposed on a side of the light convergence module 18 opposite to the beam adjustment module 14, and can be designed as a light pipe or other similar optical element.

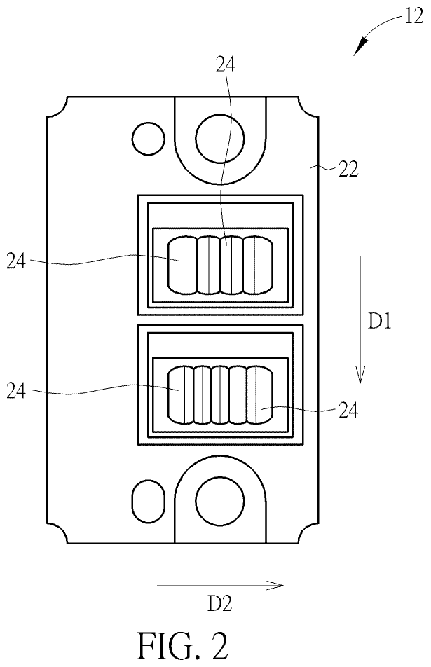

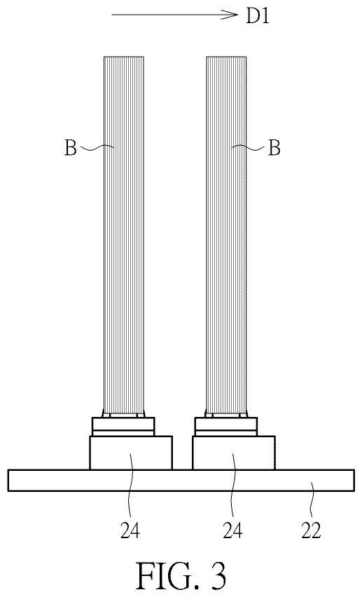

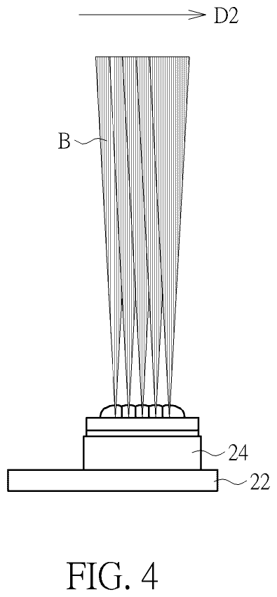

Please refer to FIG. 2 to FIG. 4. FIG. 2 is a diagram of the asymmetric laser light source 12 according to the embodiment of the present invention. FIG. 3 and FIG. 4 are lateral views of the asymmetric laser light source 12 in other view angles according to the embodiment of the present invention. The asymmetric laser light source 12 can include a circuit board 22 and a plurality of laser units 24. The plurality of laser units 24 can be arranged adjacent to each other, and the circuit board 22 can have a rectangular shape. The asymmetric laser light source 12 can emit illumination light beams B having different sizes in a first direction D1 and a second direction D2 that are interlaced with each other. The foresaid size can be interpreted as an illumination range or collimation of the light beam; as shown in FIG. 2 to FIG. 4, the laser unit 24 can emit collimated light beams; since a chip size of the asymmetric laser light source 12 can have an asymmetric aspect ratio, the illumination light beams B emitted by the laser units 24 can have different sizes in different directions after being superimposed.

The illumination light beams B emitted by the asymmetric laser light source 12 can pass through the anisotropic diffusion module 16, the beam adjustment module 14 and the light convergence module 18 to project onto the light collecting module 20. The beam adjustment module 14 can adjust the beam size of the illumination light beam B; if the illumination light beams B emitted by the asymmetric laser light source 12 has different collimation in different directions (which means different beam sizes), the beam size of the illumination light beam B in the first direction D1 and the second direction D2 can be inconsistent in response to beam expansion adjustment of the beam adjustment module 14. Therefore, the illumination device 10 of the present invention can design the anisotropic diffusion module 16 that has different optical properties respectively in the first direction D1 and in the second direction D2, and further utilize the anisotropic diffusion module 16 to calibrate the illumination light beam B, so that the beam size of the illumination light beam B can be consistent in the first direction D1 and the second direction D2.

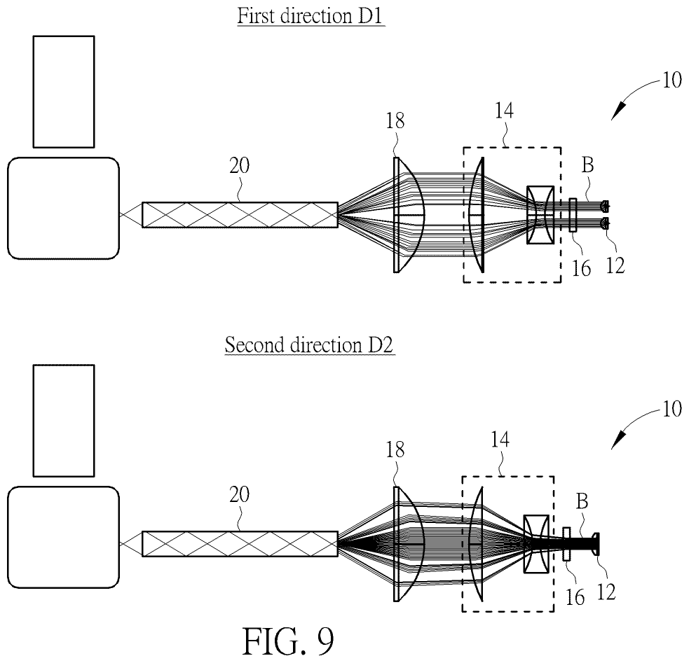

When the illumination light beam B is adjusted by beam expansion or beam contraction of the beam adjustment module 14, the illumination light beam B can pass through the light convergence module 18 for convergence. The anisotropic diffusion module 16 can have different homogenization abilities for the light beam in different directions; for example, the light beam in the first direction D1 can be adjusted slightly, and the light beam in the second direction D2 can be adjusted largely. The beam size of the illumination light beam B which passes through the anisotropic diffusion module 16 can be consistent in the first direction D1 and the second direction D2, so the illumination light beam B can be projected into the light collecting module 20 at the same angle both in the first direction D1 and the second direction D2. That is, the illumination light beam B can have the same projection angle in the first direction D1 and the second direction D2, and the can have the same number of reflection in the first direction D1 and the second direction D2 after entering the light collecting module 20, so as to effectively provide uniform color illumination. Please refer to FIG. 9. FIG. 9 is a diagram of difference in the illumination light beam B emitted by the illumination device 10 and entering the light collecting module 20 along different directions according to the embodiment of the present invention. As shown in FIG. 9, the illumination light beam B can have the same projection angle and the same number of reflection (which means a crossing angle and a density of the light beam in the light collecting module 20) in different directions when entering the light collecting module 20.

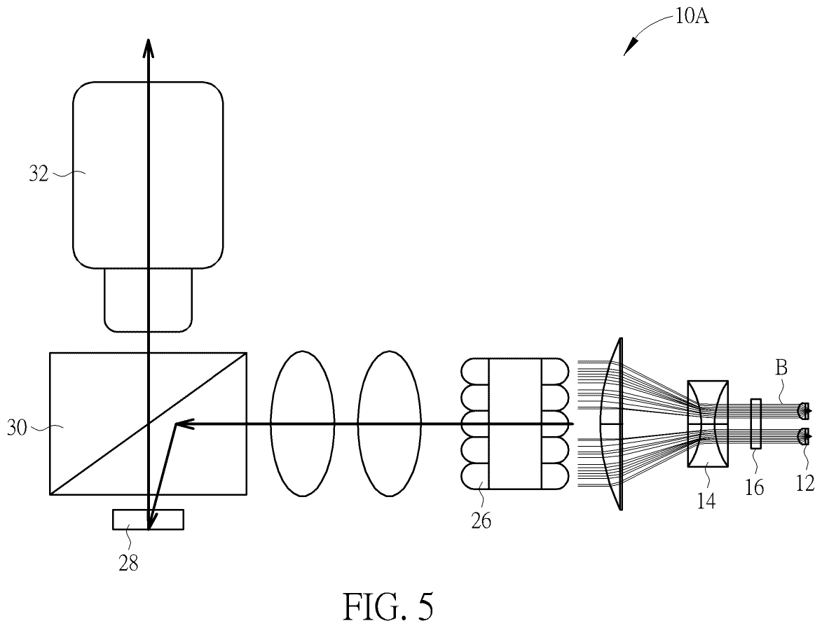

The anisotropic diffusion module 16 may be applied for other types of projector architecture. Please refer to FIG. 5. FIG. 5 is an architecture diagram of the illumination device 10A according to another embodiment of the present invention. In the embodiment, elements having the same numerals have the same structures and functions, and a detailed description is omitted herein for simplicity. The illumination device 10A can optionally include the asymmetric laser light source 12, the beam adjustment module 14, the anisotropic diffusion module 16, a lens assembly 26, a projection pattern generator 28, a light refracting component 30 and a projection lens 32. The lens assembly 26 can be a compound eye lens, which may be changed in accordance with an actual demand. The lens assembly 26 can be disposed adjacent to the beam adjustment module 14, and used to guide the illumination light beam B towards the projection pattern generator 28. The projection pattern generator 28 can be disposed on a side of the lens assembly 26 opposite to the beam adjustment module 14. The light refracting component 30 and the projection lens 32 can be disposed adjacent to the projection pattern generator 28. The light refracting component 30 can project the projection pattern provided by the projection pattern generator 28 through the projection lens 32.

The anisotropic diffusion module 16 can effectively increase a spot area of the illumination light beam B projected onto the lens assembly 26 (such as the compound eye lens). The beam size of the illumination light beam B can be adjusted by the lens assembly 26 (such as the compound eye lens), and then the illumination light beam B can be projected onto the projection lens 32 through the projection pattern generator 28 and the light refracting component 30. In the present invention, the anisotropic diffusion module 16 can be preferably cooperated with the asymmetric laser light source 12 and the beam adjustment module 14; a combination of other optical elements can depend on the design demand, which is not limited to the foresaid embodiments, and possible variation can be omitted herein for simplicity.

Please refer to FIG. 2 to FIG. 4. A preset aspect ratio of the chip size of the asymmetric laser light source 12 in the first direction D1 and the second direction D2 can be ranged between 2:1 and 4:1; variation of the preset aspect ratio can depend on a number and an arrangement density of the laser units 24. As the view angle along the first direction D1 shown in FIG. 3, there are several laser units 24 behind each of the two laser units 24, and the illumination light beam B emitted by each row of the laser units 24 can be superimposed together to provide the collimation shown in FIG. 3. As the view angle along the second direction D2 shown in FIG. 4, each row of the laser units 24 can be disposed adjacent to each other, and the illumination light beams B respectively emitted by the laser units 24 are not superimposed and does not provide the collimation shown in FIG. 4.

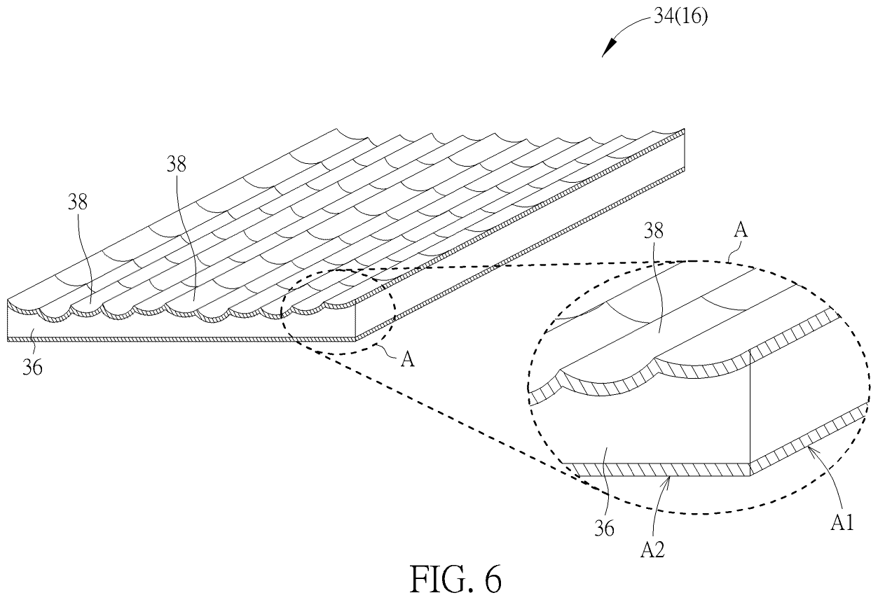

In the present invention, the anisotropic diffusion module 16 can be arranged in front of an optical path of the asymmetric laser light source 12; the anisotropic diffusion module 16 can provide different homogenization effects in different directions, so that the illumination light beam B can be adjusted to have the same beam size in the first direction D1 and the second direction D2. A variety of examples of the anisotropic diffusion module 16 can be provided as below, but the actual application is not limited to the said examples. Please refer to FIG. 6 to FIG. 8. FIG. 6 to FIG. 8 are diagrams of the anisotropic diffusion module 16 according to different embodiments of the present invention. As shown in FIG. 6, the anisotropic diffusion module 16 can include an anisotropic diffusing component 34, and the anisotropic diffusing component 34 can have a transparent substrate 36 and some asymmetric lens unit 38. A number of the asymmetric lens unit 38 can be plural, and the asymmetric lens units 38 can be distributed on the transparent substrate 36. The asymmetric lens unit 38 can be made by transparent material, and designed as an oval shape, a rectangular shape, or any other shapes.

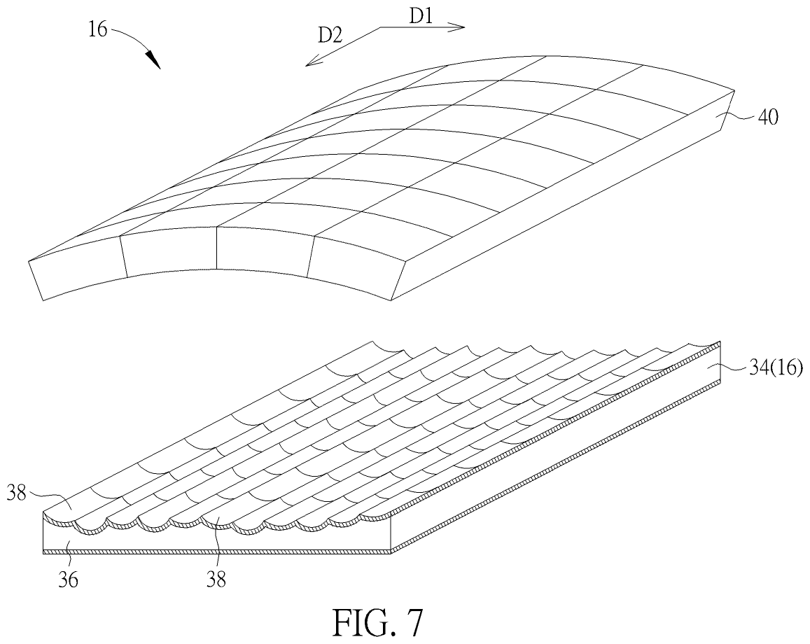

In an enlarged area A of FIG. 6, the asymmetric lens unit 38 can have a minor axis A1 and a major axis A2, and a ratio of the minor axis A1 to the major axis A2 of the asymmetric lens unit 38 can correspond to the preset aspect ratio of the chip size of the asymmetric laser light source 12 in the first direction D1 and the second direction D2, so as to achieve as an anisotropic beam homogenization function. As shown in FIG. 7, the anisotropic diffusion module 16 can further include the anisotropic diffusing component 34 and a lenticular lens 40; two sections of the lenticular lens 40 in the first direction D1 and the second direction D2 can be respectively a convex and concave arc structure and a rectangular structure, and the ratio of the minor axis in the first direction D1 to the major axis in the second direction D2 of the lenticular lens 40 can correspond to the preset aspect ratio of the chip size of the asymmetric laser light source 12 in the first direction D1 and the second direction D2.

It should be mentioned that elements in FIG. 6 and FIG. 7 are drawn in a manner of clearly showing features of the anisotropic diffusing component 34 and the lenticular lens 40, and therefore arrangement of the anisotropic diffusing component 34 and the lenticular lens 40 is not limited to the embodiments shown in FIG. 6 and FIG. 7, which depends on relative position and design demand of the anisotropic diffusion module 16 and the asymmetric laser light source 12.

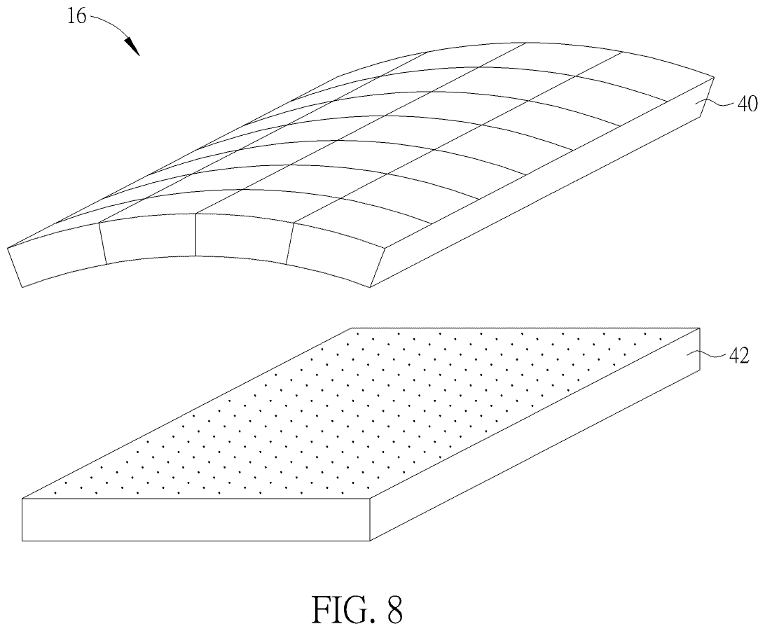

As shown in FIG. 8, the anisotropic diffusion module 16 can optionally include the lenticular lens 40 and a diffusing component 42 disposed adjacent to each other. The two sections of the lenticular lens 40 in the first direction D1 and the second direction D2 can respectively be the convex and concave arc structure and the rectangular structure, which is similar to the foresaid embodiment; the diffusing component 42 can be a common light diffusion plate, and used to diffuse the light beams both in the vertical direction and the horizontal direction. In this embodiment, the diffusing component 42 does not have the anisotropic beam homogenization function, and can mainly utilize design of the lenticular lens 40 to adjust the illumination light beam B of the asymmetric laser light source 12 to have the same beam size in the first direction D1 and the second direction D2. That is to say, the lenticular lens 40 (which can be shown in FIG. 7 and FIG. 8) can be individually applied for the anisotropic diffusion module 16, and a diffusion layer can be coated on an outer surface of the lenticular lens 40 for replacing the diffusing component 42 of the embodiment shown in FIG. 8.

In conclusion, the illumination device of the present invention can dispose the anisotropic diffusion module in front of the asymmetric laser light source, and the illumination light beam of the asymmetric laser light source can have different beam sizes in different directions due to arrangement of the laser units of the asymmetric laser light source, so that different optical homogenization features of the anisotropic diffusion module in different directions can be utilized to correct or calibrate the illumination light beam, and the illumination light beam converged into the light collecting module can have the same incident angle in different directions, for effectively increasing color uniformity of illumination. The illumination device of the present invention is not limited to various types of projection apparatus; any optical apparatus that needs to improve poor color uniformity can belong to a design scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination device, comprising:
an asymmetric laser light source adapted to emit an illumination light beam having different sizes in a first direction and a second direction that are interlaced with each other;
a beam adjustment module adapted to adjust a beam size of the illumination light beam; and
an anisotropic diffusion module disposed between the asymmetric laser light source and the beam adjustment module, the anisotropic diffusion module having different optical properties in the first direction and the second direction, and the beam size of the illumination light beam being consistent in the first direction and the second direction.

2. The illumination device of claim 1, further comprising:
a light convergence module disposed adjacent to the beam adjustment module; and
a light collecting module disposed on a side of the light convergence module opposite to the beam adjustment module, the anisotropic diffusion module being adapted to project the illumination light beam into the light collecting module at the same angle in both the first direction and the second direction.

3. The illumination device of claim 1, further comprising:
a lens assembly disposed adjacent to the beam adjustment module;
a projection pattern generator disposed on a side of the lens assembly opposite to the beam adjustment module;
a light refracting component disposed adjacent to the projection pattern generator; and
a projection lens disposed adjacent to the light refracting component, the anisotropic diffusion module being adapted to increase a spot area of the illumination light beam projected onto the lens assembly, and the illumination light beam passing through the projection pattern generator and the light refracting component to arrive the projection lens.

4. The illumination device of claim 1, wherein a preset aspect ratio of a chip size of the asymmetric laser light source in the first direction and the second direction is ranged between 2:1 and 4:1.

5. The illumination device of claim 1, wherein the anisotropic diffusion module comprises an anisotropic diffusing component, the anisotropic diffusing component comprises a transparent substrate and a plurality of asymmetric lens units, and the plurality of asymmetric lens units is distributed on the transparent substrate.

6. The illumination device of claim 5, wherein a ratio of a minor axis to a major axis of one of the plurality of asymmetric lens units corresponds to a preset aspect ratio of a chip size of the asymmetric laser light source in the first direction and the second direction.

7. The illumination device of claim 5, wherein the anisotropic diffusion module further comprises a lenticular lens, two sections of the lenticular lens in the first direction and the second direction respectively are a convex and concave arc structure and a rectangular structure.

8. The illumination device of claim 7, wherein a ratio of a minor axis to a major axis of the lenticular lens respectively in the first direction and the second direction corresponds to a preset aspect ratio of a chip size of the asymmetric laser light source in the first direction and the second direction.

9. The illumination device of claim 1, wherein the anisotropic diffusion module comprises a diffusing component and a lenticular lens disposed adjacent to each other, two sections of the lenticular lens in the first direction and the second direction respectively are a convex and concave arc structure and a rectangular structure.

10. The illumination device of claim 1, wherein the anisotropic diffusion module comprises a lenticular lens, a diffusion layer is formed on an outer surface of the lenticular lens, two sections of the lenticular lens in the first direction and the second direction respectively are a convex and concave arc structure and a rectangular structure.
